(19) United States
(12) Patent Application Publication
(10) Pub. No.: US 2025/0233027 A1
(43) Pub. Date: Jul. 17, 2025

(54) METHOD AND APPARATUS FOR EVALUATING INFLUENCE OF PROCESS ON SEMICONDUCTOR DEVICE PERFORMANCE AND APPLICATION THEREOF

(71) Applicants: SK hynix Inc., Icheon-si (KR); POSTECH ACADEMY-INDUSTRY FOUNDATION, Pohang-si (KR)

(72) Inventors: Seong Joo Han, Icheon-si (KR); Choong Ki Kim, Icheon-si (KR); Hong Chul Byun, Icheon-si (KR); Min Soo Yoo, Icheon-si (KR); Hyeok Yun, Pohang-si (KR); Rock Hyun Baek, Pohang-si (KR)

(21) Appl. No.: 18/987,848

(22) Filed: Dec. 19, 2024

(30) Foreign Application Priority Data
Dec. 20, 2023 (KR) 10-2023-0187638

(51) Int. Cl. H01L 21/66; G01R 31/26; G01R 31/28

(52) U.S. Cl. CPC H01L 22/14; G01R 31/2601; G01R 31/2831; H01L 22/34

(57) ABSTRACT

Disclosed are a method and device for evaluating the influence of a process on the performance of a semiconductor device and their application. The disclosed method for evaluating influence of a process on performance of a semiconductor device may include a step for obtaining an EPM data set that includes a plurality of EPMs measured from a plurality of semiconductor device samples manufactured under a plurality of different process conditions; establishing a plurality of EPM groups by grouping EPMs that exhibit correlations within the EPM data set; performing data component analysis on each of a plurality of EPM groups to derive a plurality of PCs of the EPMs within the plurality of EPM groups; training an artificial neural network to output a FOM for the semiconductor device; performing an input influence evaluation for each PC of individual semiconductor device samples.

### CROSS-REFERENCES TO RELATED APPLICATION

The present application claims, under 35 U.S.C. § 119(a), the benefit of Korean Patent Application No. 10-2023-0187638, filed on Dec. 20, 2023, which is hereby incorporated by reference in its entirety.

### BACKGROUND

### 1. Field

Embodiments of the present disclosure relate to the development and evaluation of semiconductor devices and their applications, and more particularly, to an evaluation method and a device, capable of being utilized in the development process of semiconductor devices, and their applications.

### 2. Description of the Related Art

The competitive landscape in miniaturization and integration technologies for semiconductor processes necessitates the development of devices with reduced costs and development times, alongside improved performance and enhanced mass production yields. To address these demands, technologies leveraging machine learning through artificial neural networks have been proposed as promising solutions to streamline the semiconductor device development process.

However, existing technologies predominantly assess the impact of process variations based on the variance within a group of samples, rather than analyzing individual samples of the semiconductor device. This reliance on group-based evaluation has inherent limitations, including the inability to effectively identify and assess factors, such as outliers, that may have caused defects. Furthermore, the existing technologies fail to separately qualify the extent to which specific unit processes in the manufacturing workflow influence device performance.

In the context of semiconductor process development, it is critical to accurately determine how device characteristics are altered by various unit processes under differing process conditions. This requires a technology capable of isolating and evaluating the specific impact of each unit process on the device characteristics to clarify the influence of individual processes. In addition, a technology is required to directly assess the influence of processes on the device performance by analyzing individual sample data, rather than relying solely on aggregated sample group data.

### SUMMARY

The technological object to be achieved by the present disclosure is to provide a method for evaluating the influence of a process on the performance of a semiconductor device, capable of identifying the influence of individual unit processes by separately evaluating the extent to which each unit process impacts the performance of the semiconductor device during the development process of the semiconductor device.

In addition, the technological object to be achieved by the present disclosure is to provide a method for evaluating the influence of a process on the performance of a semiconductor device, which may evaluate the influence of a process on the performance of the semiconductor device by directly deriving the influence from individual samples, rather than relying on sample groups, during the development process of the semiconductor device.

In addition, the technological object to be achieved by the present disclosure is to provide a device for evaluating the influence of a process on the performance of a semiconductor device which may perform the method described above.

In addition, the technological object to be achieved by the present disclosure is to provide an application of the method and the device for evaluating the influence of the process on the performance of the semiconductor device described above.

The objects to be solved by the present disclosure are not limited to the objects mentioned above, and other objects not mentioned may be understood by those skilled in art from the description below.

According to one embodiment of the present invention, there is provided a method for evaluating influence of a process on the performance of a semiconductor device comprising: obtaining an EPM data set that includes a plurality of electrical measurement parameters (EPMs) measured from a plurality of semiconductor device samples manufactured under a plurality of different process conditions, and establishing a plurality of EPM groups by grouping EPMs that exhibit correlations within the EPM data set; performing data component analysis on each of a plurality of EPM groups to derive a plurality of principal components (PCs) for the EPMs within the plurality of EPM groups; training an artificial neural network to output a figure of merit (FOM) for the semiconductor device by using the plurality of PCs derived from the plurality of EPM groups as inputs; performing an input influence evaluation for each PC of individual semiconductor device samples selected from the plurality of semiconductor device samples using the trained artificial neural network to determine the degree of influence each PC has on the FOM for the semiconductor device; and summing the influences of the plurality of PCs on the FOM within each EPM group to determine influence of a unit process or unit process group corresponding to the EPM group.

The input influence evaluation may be performed by using the non-linear sensitivity decomposition (NLSD) method.

When Z represents one semiconductor device sample including a plurality of PCs, and z (i.e., z₁, z₂, . . . , zᵢ, . . . , z_{D}) represents each PC of the one semiconductor device sample in the following mathematical expression 1, the input influence evaluation method may comprises to determine an influence degree of a given PC corresponding to the i-th input (zᵢ) on the FOM by obtaining a difference value between a first output value of the trained artificial neural network (learned artificial neural network) derived when values corresponding to the mathematical expression 2 below are used as a first input group and a second output value of the trained artificial neural network (learned artificial neural network) when values corresponding to the mathematical expression 3 below are used as the second input group, and to add up a plurality of difference values using mathematical expression 4 below.

$$Z = [ \begin{matrix}{z}_{1} & {z}_{2} & … & {z}_{i} & … & {z}_{D}\end{matrix} ] \qquad < Mathematical Expression 1 >$$

$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$

$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$

$${\sum }_{j = 0}^{n - 1} \qquad < Mathematical Expression 4 >$$

Here, in a case that an interval corresponding to a difference value of each PC of a PC coordinate (Zₜ) of a semiconductor device sample corresponding to a target with respect to a PC coordinate (Z₀) corresponding to an origin is divided into n equal sections (sections or parts), and the difference value for the i-th input (zᵢ) obtained individually in the n sections are added up to determine the influence of the given PC on the FOM, when a j is 0 (i.e., j=0), it may correspond to the first section among the n sections, and when the j is n-1, it may correspond to the last section among the n sections. In addition, the Zₜⱼ may be the first input group, and the z₁ₜⱼ, z₂ₜⱼ, . . . , z₁ₜⱼ, . . . , z_{Dtj} may correspond to input values within the Zₜⱼ. The Zₜⱼ^{I+} may be the second input group, and the z₁ₜⱼ, z₂ₜⱼ, . . . , z₁ₜⱼ₊₁), . . . , z_{Dtj} may correspond to input values within the Zₜⱼ^{I+}.

The semiconductor device sample corresponding to the origin may be a semiconductor device sample manufactured according to baseline conditions corresponding to basic experimental conditions.

The influence of the unit process or unit process group corresponding to each EPM group on the FOM may be determined by performing the input influence evaluation for each of the plurality of semiconductor device samples, and summing the influences on the FOM determined from the plurality of PCs for each of the plurality of semiconductor device samples by EPM group.

According to another embodiment of the present invention, there is provided a method for setting semiconductor device manufacturing parameters, and including a method for evaluating the influence of a process on the performance of the semiconductor device as described the.

According to another embodiment of the present invention, there is provided an apparatus for evaluating influence of a process on the performance of a semiconductor device including a preprocessing module and an analysis module. The preprocessing module is configured to obtain an EPM data set that includes a plurality of electrical measurement parameters (EPMs) measured from a plurality of semiconductor device samples manufactured under a plurality of different process conditions, and establish a plurality of EPM groups by grouping EPMs that exhibit correlations within the EPM data set, and to perform data component analysis on each of the plurality of EPM groups to derive a plurality of principal components (PCs) for the EPMs within the plurality of EPM groups, and analysis module is configured to train an artificial neural network to output a figure of merit (FOM) for the semiconductor device by using the plurality of PCs derived from the plurality of EPM groups as inputs, to derive degree of influence each PC has on the FOM of the semiconductor device by performing an input influence evaluation for each PC of individual semiconductor device samples selected from the plurality of semiconductor device samples by using the trained artificial neural network, to sum the influences of the plurality of PCs on the FOM within each EPM group to determine influence of a unit process or unit process group corresponding to the EPM group.

The analysis module may be configured to perform the input influence evaluation by using a non-linear sensitivity decomposition (NLSD) method.

When Z represents one semiconductor device sample including a plurality of PCs, and z (i.e., z₁, z₂, . . . , zᵢ, . . . , Z_{D}) represents each PC of the one semiconductor device sample through an input influence decomposition evaluation, in the mathematical expression 1 below, the analysis module may be configured to determine an influence of a given PC corresponding to the i-th input (zᵢ) on the FOM by obtaining a difference value between a first output value of the trained artificial neural network derived when values corresponding to mathematical expression 2 below are used as a first input group, and a second output value of the trained artificial neural network derived when values corresponding to the mathematical expression 3 below are used as a second input group, and adding up a plurality of difference values using mathematical expression 4 below,

$$Z = [ \begin{matrix}{z}_{1} & {z}_{2} & … & {z}_{i} & … & {z}_{D}\end{matrix} ] \qquad < Mathematical Expression 1 >$$

$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$

$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$

$${\sum }_{j = 0}^{n - 1} \qquad < Mathematical Expression 4 >$$

Here, when dividing the interval corresponding to a difference value of each PC of a PC coordinate (Zₜ) of a semiconductor device sample corresponding to a target with respect to a PC coordinate (Z₀) corresponding to an origin into n equal sections (sections or parts), and adding up difference values for the i-th input (zᵢ) obtained individually in the n sections to derive the influence of the given PC on the FOM, if a j is 0 (i.e., j=0), it may correspond to the first section among the n sections, and if the j is n−1, it may correspond to the last section among the n sections. In addition, the Zₜⱼ may be the first input group, and the z₁ₜⱼ, z₂ₜⱼ, . . . , z₁ₜⱼ, . . . , z_{Dtj} may correspond to input values within the Zₜⱼ. The Zₜⱼ^{I+} may be the second input group, and the z₁ₜⱼ, z₂ₜⱼ, . . . , zᵢₜⱼ₍ⱼ₊₁₎, z_{Dtj} may correspond to input values within the Zₜⱼⁱ⁺.

The semiconductor device sample corresponding to the origin may be a semiconductor device sample manufactured under baseline conditions corresponding to basic experimental conditions.

The analysis module may be configured to determine the influence of the unit process or the unit process group corresponding to the EPM group on the FOM by performing the input influence evaluation for each of the plurality of semiconductor device samples, and summing the influences on the FOM determined from the plurality of PCs for each of the plurality of semiconductor device samples by EPM group,

According to another embodiment of the present invention, a semiconductor device manufacturing parameter setting device including a process influence evaluation device for the—described semiconductor device performance is provided.

According to another embodiment of the present invention, there is provided a computer program stored in a computer readable storage medium. When executed by a computing device having one or more instructions, and the instruction includes one or more processors, the computer program is provided to perform a step for causing the computing device to obtain an EPM data set that includes a plurality of electrical measurement parameters (EPMs) measured from a plurality of semiconductor device samples manufactured under a plurality of different process conditions, and to establish a plurality of EPM groups by grouping EPMs that exhibit correlations within the EPM data set; a step for deriving a plurality of principal components (PCs) for the EPMs within the plurality of EPM groups by performing data component analysis on each of a plurality of EPM groups; a step for training an artificial neural network to output a figure of merit (FOM) for a semiconductor device by using the plurality of PCs derived from the plurality of EPM groups as inputs; a step for determining the degree of influence PC has on the FOM for the semiconductor device by performing an input influence evaluation for each PC of individual semiconductor device samples selected from the plurality of semiconductor device samples using the trained artificial neural network; and a step of summing the influences of the plurality of PCs on the FOM within each EPM group to determine influence of a unit process or unit process group corresponding to the EPM group.

According to embodiments of the present invention, it may be applied to the development process of semiconductor devices, and the like. A method and an apparatus for evaluating the influence of a process on the performance of a semiconductor device may be implemented, which may accurately isolate and evaluate how much a unit process affects the performance of a semiconductor device by utilizing input influence analysis evaluation, so that the influence of a unit process may be clarified. In addition, according to embodiments of the present invention, a method and apparatus for evaluating the influence of a process on the performance of a semiconductor device may be implemented, which may evaluate the process influence of a defective device or a well-functioning device (a device with excellent performance) by directly deriving the influence from each sample rather than a sample group of semiconductor devices.

The method and the apparatus for evaluating the influence of the process on semiconductor device performance according to the embodiments of the present disclosure may be usefully applied to, for example, a method and an apparatus for setting semiconductor device manufacturing parameters.

However, influences of a process are not limited to the influences described in the present disclosure, and may be variously expanded within a scope that does not depart from the technological spirit and scope of the present disclosure.

### BRIEF DESCRIPTION OF THE DRAWINGS

FIG. 1 is a flowchart illustrating a method for evaluating the influence of a process on semiconductor device performance according to an embodiment of the present disclosure.

FIG. 2 is a graph illustrating a process of deriving a plurality of PCs (principal components) from an EPM group according to an embodiment of the present disclosure.

FIG. 3 illustrates a process of converting a plurality of groups of EPM data into PC domains corresponding to a plurality of PCs according to an embodiment of the present disclosure.

FIG. 4 describes a method of input influence evaluation according to an embodiment of the present disclosure.

FIG. 5 is a graph illustrating a non-linear sensitivity decomposition (NLSD) method according to an embodiment of the present disclosure.

FIG. 6 is a graph describing an LSD (linear sensitivity decomposition) method according to a comparative example.

FIG. 7 is a scatter plot of the summation of decomposed sensitivities by an NLSD method of LR (linear regression) and ANN (artificial neural network).

FIG. 8 is a scatter plot of the summation of decomposed sensitivities according to LSD and NLSD methods of a nonlinear model.

FIG. 9 is a graph illustrating the distribution of FOM data corresponding to a PDP according to an embodiment of the present disclosure.

FIG. 10 is a graph illustrating results obtained by separately evaluating the influence of a process group SDimp on a PDP in a sample with the maximum defect in the results of FIG. 9, according to an embodiment of the present disclosure.

FIG. 11 is a graph showing the results obtained by separately evaluating the influence of a process group GPat on the PDP in the sample with the maximum defect in the results of FIG. 9, according to an embodiment of the present disclosure.

FIG. 12 illustrates a heatmap of PDP influence rankings of process groups in the top 5% of defective PDP distributions along with an average PDP influence value and ranking score, according to an embodiment of the present disclosure.

FIG. 13 shows a heatmap showing the influence rankings of process groups within the bottom 5% of enhancive PDP distribution, along with the corresponding average PDP influence values and ranking scores, according to an embodiment of the present disclosure.

FIG. 14 illustrates a device for evaluating the influence of a process on semiconductor device performance according to an embodiment of the present disclosure.

FIG. 15 illustrates a computer system for implementing a method for evaluating the influence of a process on semiconductor device performance according to an embodiment of the present disclosure.

### DETAILED DESCRIPTION

Hereinafter, the embodiments of the present disclosure will be described in detail with reference to accompanying drawings.

The embodiments of the present disclosure to be described below are provided to explain the invention more clearly to those having common knowledge in the related art, and the scope of the invention is not limited by the following embodiments. The following embodiments may be modified in many different forms.

The terminology used herein is used to describe specific embodiments, and is not used to limit the invention. As used herein, terms in the singular form may include the plural form unless the context clearly dictates otherwise. Also, as used herein, the terms “comprise” and/or “comprising” specifies presence of the stated shape, step, number, action, member, element and/or group thereof; and does not exclude presence or addition of one or more other shapes, steps, numbers, actions, members, elements, and/or groups thereof. In addition, the term “connection” as used herein means not only a concept that certain members are directly connected, but also a concept that other members are further interposed between the members to be indirectly connected.

In addition, in the present specification, when a member is said to be located “on” another member, this includes not only a case in which a member is in contact with another member but also a case in which another member is present between the two members. As used herein, the term “and/or” includes any one and any combination of one or more of those listed items. In addition, as used herein, terms such as “about”, “substantially”, etc. are used as a range of the numerical value or degree, in consideration of inherent manufacturing and material tolerances, or as a meaning close to the range. Furthermore, accurate or absolute numbers provided to aid the understanding of the present application are used to prevent an infringer from using the disclosed present invention unfairly.

Hereinafter, the same reference numerals refer to the same elements throughout the detailed description.

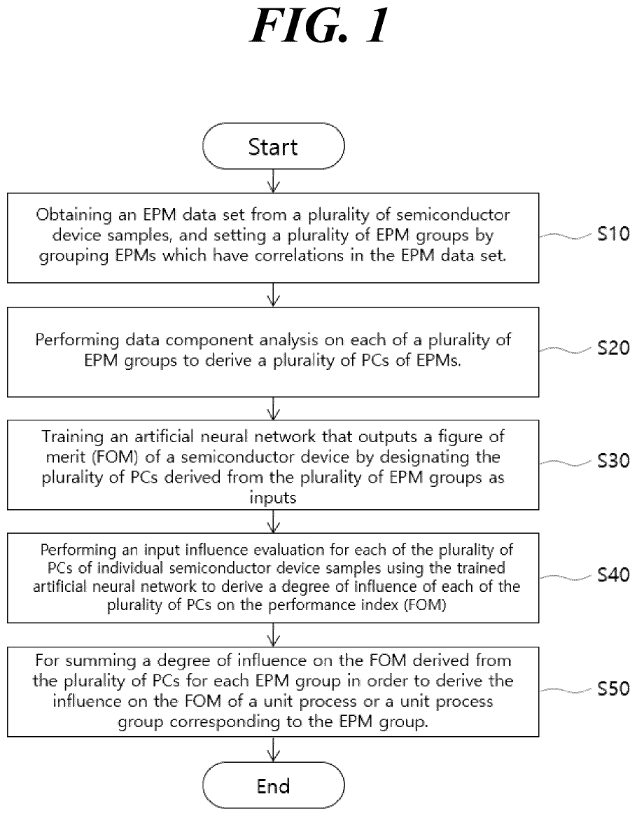

FIG. 1 is a flowchart illustrating a method for evaluating the influence of a process on semiconductor device performance according to an embodiment of the present disclosure.

Referring to FIG. 1, the method may include step S10 for obtaining an electrical measurement parameter (EPM) data set including a plurality of electrical measurement parameters (EPMs) measured from a plurality of semiconductor device samples manufactured under a plurality of different process conditions, and setting a plurality of EPM groups by grouping EPMs that have correlations in the EPM data set; step S20 for performing data component analysis on each of the plurality of EPM groups to derive a plurality of PCs (principal components) of EPMs belonging to the plurality of EPM groups; step S30 for training an artificial neural network that outputs a figure of merit (FOM) of a semiconductor device by designating the plurality of PCs derived from the plurality of EPM groups as inputs; step S40 for performing an input influence evaluation for each of the plurality of PCs of individual semiconductor device samples selected from the plurality of semiconductor device samples using the trained artificial neural network to derive the degree of influence of each of the plurality of PCs on the performance index (FOM) of the semiconductor device; and step S50 for summing the influences of the plurality of PCs on the FOM for each EPM group in order to derive the influence on the FOM of a unit process or unit process group corresponding to the EPM group.

In the step S10, the plurality of semiconductor device samples may be manufactured through splits of a plurality of process conditions. In other words, the plurality of semiconductor device samples may be manufactured by a plurality of condition splits. The plurality of semiconductor device samples may be manufactured for each process condition (i.e., for each condition split). In the step 510, a semiconductor device sample (e.g., a baseline semiconductor device sample) may be manufactured according to baseline conditions (or the process conditions) corresponding to basic experimental conditions. The baseline semiconductor device sample may be manufactured in a plurality of units. The baseline condition may also be considered as one condition split. A plurality of semiconductor device samples manufactured under a plurality of process conditions having the conditions changed from the baseline condition may be manufactured.

Here, the process conditions may include design parameters used to manufacture a semiconductor device having a specific structure, as manufacturing parameters of the semiconductor device. For example, when the semiconductor device is a transistor, the process conditions (or manufacturing parameters) may include gate length, gate insulator thickness, doping concentration, junction gradient, gate stack height, etc.

The plurality of electrical measurement parameters (EPMs) may be measured from the plurality of semiconductor device samples manufactured under the above-described different process conditions. That is, the plurality of electrical parameter measurement values (EPMs) may be obtained from the plurality of semiconductor device samples. An EPM may be an electrically measured parameter value from a manufactured semiconductor device sample. For example, if the semiconductor device sample is a transistor, the EPMs may include breakdown voltage (BV), electrical critical dimension (ECD), effective oxide thickness (EOT), drain saturation current (Idsat), off-current (Idoff), etc. Even if the process conditions are only one, EPM data may be derived as distributed data due to process variability and random variability.

In the step S10, the plurality of EPM groups may be determined by grouping EPMs which have correlations in the EPM data set. In other words, EPMs which have correlations in the EPM data set may be classified into a plurality of groups. The correlation may be a statistical correlation. In addition, the correlation may be multicollinearity. EPMs may have statistical correlations. For example, among EPMs, drain saturation current (Idsat) and off-current (Idoff) may have a positive correlation. Also, effective oxide thickness (EOT) and breakdown voltage (BV) may have a positive correlation, and poly depletion ratio and inversion capacitance may have a positive correlation. In addition, there are various EPMs having statistical correlations. In the EPM data set, the plurality of EPM groups may be determined by grouping EPMs having a correlation greater than a threshold value based on mutual dependency information.

Each of at least some of the above-described EPM groups may correspond to a unit process or a unit process group used in the manufacturing of a semiconductor device. For example, a first EPM group may correspond to a first unit process or a first unit process group, and a second EPM group may correspond to a second unit process or a second unit process group. The first EPM group may be set to be affected by the first unit process or the first unit process group, and the second EPM group may be set to be affected by the second unit process or the second unit process group. A corresponding unit process or unit process group may be set for each EPM group. Here, the unit process group may be a group of interconnected unit processes.

In the step S20, data component analysis may be performed on each of the plurality of EPM groups to derive a plurality of PCs (principal components) of the EPMs belonging to the plurality of EPM groups. That is, a plurality of PCs (principal components) corresponding to the main correlation axes (valid correlation axes) between the EPMs belonging to the plurality of EPM groups may be derived. The data component analysis may be any one selected from the group consisting of PCA (principal component analysis), inverse NLPCA (non-linear principal component analysis), SOM (self-organizing map), ICA (independent component analysis), and the like. Through the data component analysis, a plurality of PCs corresponding to the main correlation axes between EPMs in an EPM group where correlation exists may be extracted.

Accordingly, the plurality of PCs may be obtained to correspond to the main correlation axes between EPMs, through one of PCA, inverse NLPCA, SOM, ICA, etc. A corresponding PC (principal component) may be derived from each of the EPMs. A process for deriving a plurality of PCs from a plurality of EPM groups may be described as a process for converting EPM-based data (data set) into a PC domain, which allows for independent analysis.

In the step S30, the artificial neural network may be trained by inputting the plurality of PCs derived from the plurality of EPM groups. That is, a neural network model that outputs a FOM may be trained by inputting the plurality of PCs. For example, there may be labels for FOMs of the plurality of semiconductor device samples, and the artificial neural network may be trained using the plurality of PCs and the labels.

In the step S40, the input influence evaluation is performed on each of a plurality of PCs of individual semiconductor device samples selected from the plurality of semiconductor device samples using the trained artificial neural network, thereby deriving the degree of influence of each of the plurality of PCs on the figure of merit (FOM) of the semiconductor device. According to an embodiment, the input influence evaluation may be performed using a non-linear sensitivity decomposition (NLSD) method.

According to a more specific embodiment, in connection with the input influence evaluation, when Z represents one semiconductor device sample including PCs, and z (i.e., z₁, z₂, . . . , zᵢ, . . . , Z_{D}) represents each PC of the one semiconductor device sample in the following mathematical expression 1, it may be configured to derive the influence of the given PC corresponding to the i-th input (zᵢ) on the FOM by obtaining a difference value between a first output value of the artificial neural network (trained artificial neural network) derived when values corresponding to the mathematical expression 2 below are used as a first input group and a second output value of the artificial neural network (trained artificial neural network) derived when values corresponding to the mathematical expression 3 below are used as a second input group, and by adding up a plurality of difference values, as illustrated in mathematical expression 4 below. The difference value may be a value obtained by subtracting the first output value from the second output value.

$$Z = [ \begin{matrix}{z}_{1} & {z}_{2} & … & {z}_{i} & … & {z}_{D}\end{matrix} ] \qquad < Mathematical Expression 1 >$$

$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$

$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$

$${\sum }_{j = 0}^{n - 1} \qquad < Mathematical Expression 4 >$$

Here, in a case that the interval corresponding to the difference of each PC of the PC coordinate (Zₜ) of the semiconductor device sample corresponding to a target with respect to the PC coordinate (Z₀) corresponding to the origin is divided into n equal sections (sections or parts), and the difference values for the i-th input (zᵢ) obtained individually in the n sections are added up to derive the influence of the given PC on the FOM, when the j is 0 (i.e., j=0), it may correspond to the first section among the n sections, and when the j is n−1, it may correspond to the last section among the n sections. In addition, Zₜⱼ may be the first input group, and z₁ₜⱼ, z₂ₜⱼ, . . . , z₁ₜⱼ, . . . , z_{Dtj} may correspond to input values of the first input group Zₜⱼ. Zₜⱼ^{I+} may be the second input group, and z₁ₜⱼ, z₂ₜⱼ, z₁ₜⱼ+1), z_{Dtj}, may correspond to input values of the second input group Zₜⱼ^{I+}.

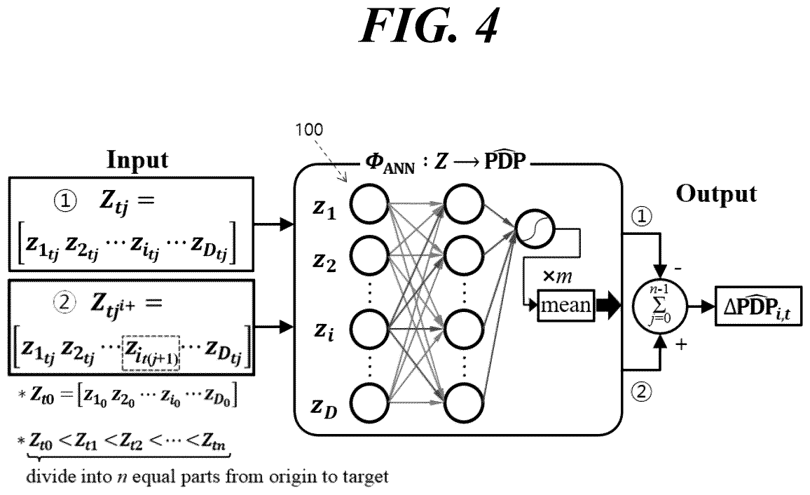

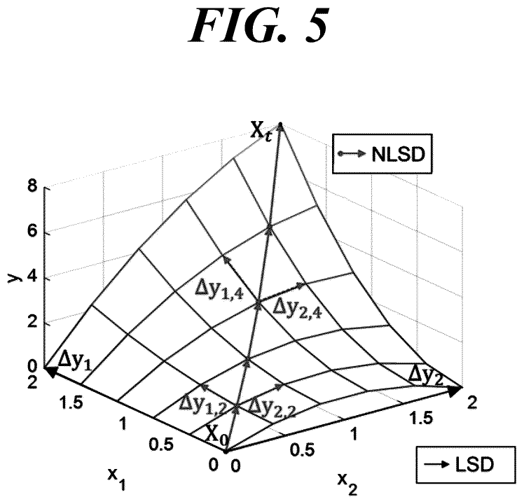

As described above, the influence of the given PC corresponding to the i-th input (zᵢ) on the FOM may be separated and derived by adding up a plurality of difference values as illustrated in mathematical expression 4. In this way, the influence on the FOM may be derived for each of the plurality of PCs. The input influence evaluation using mathematical expressions 1 to 4 may be an example of the NLSD (non-linear sensitivity decomposition) method. The input influence evaluation will be described in more detail later with reference to FIGS. 4 and 5.

According to one embodiment, the semiconductor device sample corresponding to the origin may be a semiconductor device sample manufactured under baseline conditions corresponding to basic experimental conditions. A semiconductor device sample corresponding to a target may be set for the semiconductor device sample corresponding to the origin, and an evaluation may be performed on the semiconductor device sample corresponding to the target. However, in some cases, the semiconductor device sample corresponding to the origin may not be a semiconductor device sample manufactured under the baseline conditions. Alternatively, the origin may be determined as a point which is average of the entire semiconductor device sample set. In addition, PC characteristics (EPM characteristics) of a semiconductor device sample to be analyzed may be determined as a target point.

In order to derive the influence of the unit process or unit process group corresponding to the EPM group on the FOM at the step S50, the influence on the FOM derived from the plurality of PCs may be added for each EPM group. Since the EPM group may correspond to a predetermined unit process or unit process group, the influence on the FOM of the unit process or unit process group may be derived by adding up the influences on the FOM derived from the plurality of PCs for each EPM group. Accordingly, it is possible to quantify the extent to which the predetermined unit process or unit process group has influenced the FOM of a semiconductor device.

According to one embodiment, by performing the input influence evaluation for each of the plurality of semiconductor device samples, and adding up the influences derived from the plurality of PCs for each of the plurality of semiconductor device samples by EPM group, the influence of the unit process or unit process group corresponding to the EPM group on the FOM may be derived. This approach enables the identification of the influence of the unit process or unit process group on the FOM.

According to embodiments of the present disclosure, a method for evaluating the influence of a process on semiconductor device performance may be implemented. This method enables the accurate separation and assessment of the extent to which a unit process (or group of unit processes) affects the performance of a semiconductor device by utilizing input influence decomposition evaluation, thereby clarifying the influence of the unit process (or group of unit processes).

In addition, according to embodiments of the present disclosure, a method for evaluating the influence of a process on the semiconductor device performance may be implemented. This method allows for the evaluation of the influence of a process on both defective devices and well-functioning device (i.e., devices with excellent performance) by directly deriving the influence from individual samples, rather than sample groups of semiconductor devices.

The existing technologies evaluate the influence based on the variance within a group of samples, without considering each individual sample of a semiconductor device. Since these methods evaluate only the average influence across a group of samples, it becomes difficult to accurately identify the cause of defects. Furthermore, the existing technologies may fail to separately evaluate the extent to which a specific unit process applied during the manufacturing semiconductor devices affects the performance of the devices.

However, according to embodiments of the present disclosure, it is possible to accurately separate and evaluate the extent to which a unit process (or group of unit processes) affects the characteristics of the semiconductor devices, thereby clarifying the influence of the unit process (or group of unit processes), and also to evaluate the influence of the process on the performance of the devices by directly deriving the influence from individual samples rather than relying on the sample groups. Additionally, according to embodiments of the present disclosure, the evaluation of the influence of a process (whether unit processes or groups of unit processes) on the performance of a semiconductor device may be conducted as a quantitative influence evaluation.

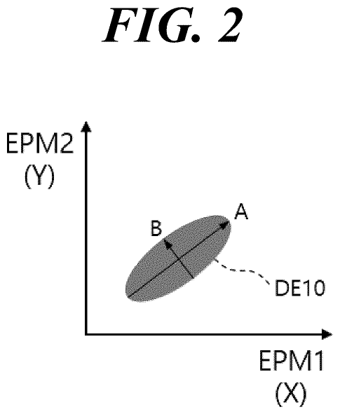

FIG. 2 is a graph illustrating a process of deriving a plurality of PCs from an EPM group. This process may be applied to a method for evaluating the influence of a process on semiconductor device performance according to an embodiment of the present disclosure.

Referring to FIG. 2, the graph shows a data distribution (DE10) between a first electrical measurement parameter (EPM1) and a second electrical measurement parameter (EPM2) that have a mutual statistical correlation. This data distribution (DE10) may be referred to as a first group of EPM data. The first group of EPM data (DE10) may be obtained from a plurality of semiconductor device samples manufactured under one process condition. The first group of EPM data (DE10) may be depicted on the EPM domain. It may be confirmed that EPM1 and EPM2 have a positive correlation. Therefore, when EPM1 is changed along the X-axis which is a general reference axis, EPM2 is changed along the Y-axis which is another reference axis, or vice versa. In this way, when any one of EPM1 or EPM2 is changed, the other one is also changed. Thus, EPM1 and EPM2 may not be analyzed independently.

According to an embodiment of the present disclosure, data component analysis for EPMs (e.g., EPM1 and EPM2) in the first group of EPM data (DE10) may be performed to extract a plurality of PCs (principal components) corresponding to main correlation axes between the EPMs including EPM1 and EPM2. The A-axis and the B-axis illustrated in FIG. 2 may correspond to the main correlation axes. Accordingly, the A-axis and the B-axis may correspond to the plurality of PCs. In FIG. 2, the A-axis may be the 45-degree axis, and the B-axis may be the 135-degree axis, which is perpendicular to the A-axis. When the first group of EPM data (DE10) is converted into the PC domain based on the A-axis and the B-axis, the correlation between the EPMs (e.g., EPM1 and EPM2) may be removed, allowing EPM1 and EPM2 to be analyzed independently.

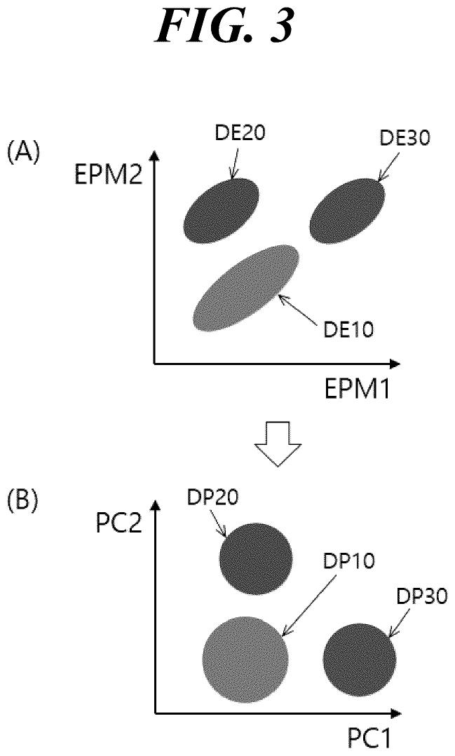

FIG. 3 illustrates a process of converting a plurality of groups of EPM data (e.g., DE10, DE20, and DE30) into PC domains corresponding to the plurality of PCs (i.e., A-axis and B-axis of FIG. 2) extracted from FIG. 2.

Referring to FIG. 3, a first group of PC data (DP10), a second group of PC data (DP20), and a third group of PC data (DP30), such as in the graph (B), may be obtained by converting the first group of EPM data (DE10), the second group of EPM data (DE20), and the third group of EPM data (DE30), such as in the graph (A), into the PC domain.

The first group of EPM data (DE10) may be obtained from a plurality of semiconductor device samples manufactured under first process conditions. The second group of EPM data (DE20) may be obtained from a plurality of semiconductor device samples manufactured under second process conditions. The third group of EPM data (DE30) may be obtained from a plurality of semiconductor device samples manufactured under third process conditions.

In PC-based data shown in the graph (B), it may be observed that there is no correlation between PC1 and PC2. Here, PC1 may correspond to the A-axis of FIG. 2, and PC2 may correspond to the B-axis of FIG. 2. In each of DP10, DP20, and DP30, there is no correlation between PC1 and PC2, and therefore, in these PC-based data, it may be possible to analyze EPMs independently. Here, for illustrative convenience, EPM1 and EPM2 and PC1 and PC2 are illustrated and described as examples, but a plurality of EPMs may exist and a plurality of PCs may exist. That is, two or more EPMs may be included in one EPM group where a correlation exists. In addition, arrangement types of the data groups may vary.

FIG. 4 describes a method of input influence evaluation. This method may be applied to a method for evaluating the influence of a process on semiconductor device performance according to an embodiment of the present disclosure.

Referring to FIG. 4, the method may include step for deriving the degree of influence of each of a plurality of PCs on a figure of merit (FOM) of a semiconductor device by performing an input influence decomposition evaluation on each of a plurality of PCs of individual semiconductor device samples selected from a plurality of semiconductor device samples using a trained artificial neural network 100. The step for deriving the degree of influence of each of the plurality of PCs on the FOM may correspond to the step S40 described above in FIG. 1. The input influence decomposition evaluation may be performed according to a non-linear sensitivity decomposition (NLSD) method.

When Z represents one semiconductor device sample containing multiple PCs, and z (i.e., z₁, z₂, . . . , zᵢ, . . . , Z_{D}) represents each PC of the one semiconductor device sample in mathematical expression 11 below, the method may include deriving the influence of a given PC corresponding to the i-th input (zᵢ) on the FOM by deriving a difference value between the first output value of the artificial neural network 100 when values corresponding to mathematical expression 12 below are used as the first input group and the second output value of the artificial neural network 100 when values corresponding to mathematical expression 13 below are used as the second input group, and adding up a plurality of difference values as shown in mathematical expression 14 below. The difference value may be a value obtained by subtracting the first output value from the second output value.

$$Z = [ \begin{matrix}{z}_{1} & {z}_{2} & … & {z}_{i} & … & {z}_{D}\end{matrix} ] \qquad < Mathematical Expression 1 >$$

$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$

$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$

$${\sum }_{j = 0}^{n - 1} \qquad < Mathematical Expression 4 >$$

Here, when dividing the interval corresponding to the difference of each PC of the PC coordinate (Zₜ) of the semiconductor device sample corresponding to a target with respect to the PC coordinate (Z₀) corresponding to the origin into n equal sections (sections or parts), and adding up the difference values for the i-th input (zᵢ) obtained individually in the n sections to derive the influence of the given PC on the FOM, if the j is 0 (i.e., j=O), it may correspond to the first section among the n sections, and if the j is n−1, it may correspond to the last section among the n sections.

In addition, Zₜⱼ may be the first input group, and z₁ₜⱼ, z₂ₜⱼ, . . . , z₁ₜⱼ, . . . , z_{Dtj} may correspond to input values of the first input group Zₜⱼ. Zₜⱼ^{I+} may be the second input group, and z₁ₜⱼ, z₂ₜⱼ, . . . , z₁ₜⱼ₍ⱼ₊₁₎, . . . , z_{Dtj} may correspond to input values of the second input group Zₜⱼ^{I+}. In the above, n may be an integer greater than or equal to 3 or an integer greater than or equal to 4.

As described above, if the plurality of difference values are added, as shown in mathematical expression 14, the influence of the given PC corresponding to the i-th input (zᵢ) on the FOM may be separated and derived. The value obtained by adding the plurality of difference values may be expressed as ΔPDP_{i,t} in FIG. 4. The ΔPDP_{i,t} may be an example of the influence of the given PC corresponding to the i-th input (zᵢ) on the FOM. PDP may mean “power delay product” as one of figures of merit (FOM) of semiconductor devices. The ΔPDP_{i,t} represents a predicted value of PDP (e.g., predicted value by neural network). If the interval corresponding to the difference of each PC of the PC coordinate (Zₜ) of the semiconductor device sample corresponding to the target with respect to the PC coordinate (Z₀) of the semiconductor device sample corresponding to the origin is divided into n equal sections (linear sections), and the difference values (i.e., partial gradients) for the i-th input (zᵢ) obtained individually in the n sections are summed (i.e., numerical integration), the influence of the given PC on the FOM, for example, ΔPDP_{i,t}, may be derived. In this way, the influence on the FOM may be derived for each of the plurality of PCs. The input influence decomposition evaluation using mathematical expressions 11 to 14 may be an example of the NLSD method.

According to one embodiment, the semiconductor device sample corresponding to the origin may be a semiconductor device sample manufactured under baseline conditions corresponding to basic experimental conditions. A semiconductor device sample corresponding to the target may be set for the semiconductor device sample corresponding to the origin, and an evaluation may be performed on the semiconductor device sample corresponding to the target.

However, in some cases, the semiconductor device sample corresponding to the origin may not be the semiconductor device sample manufactured under the baseline conditions. Alternatively, the origin may be determined as a point which is average of the entire semiconductor device sample set. In addition, the PC characteristics (or EPM characteristics) of the semiconductor device sample to be analyzed may be determined as the target point.

In FIG. 4, Zₜ₀ is the case where j is 0 in Zₜⱼ, and Zₜ₀ may be composed of z₁₀, z₂₀, z₁₀, Z_{D0}. Zₜ₀ may be the same as the PC coordinate (Z₀) of the origin. Therefore, zᵢ₀ may be the same as zᵢ of the origin. z₁₀ may represent the coordinate of the i-th axis of the origin. The first input group Zₜⱼ may increase sequentially from Zₜ₀ to Zₜ₍ₙ₋₁₎. Similarly, the second input group Zₜⱼ,+ may increase sequentially from Zₜ₀^{I+} to Z_{I(n-1)}^{I+}.

The parts marked as “m and mean” in FIG. 4 may represent using their average output values by using a plurality of artificial neural networks. Using the average output values from the plurality of artificial neural networks can enhance the stability and accuracy of predictions compared to relying on a single artificial neural network. However, using a plurality of artificial neural networks is optional, and a single artificial neural network may be used as the default approach. In this embodiment, the artificial neural network 100 may be a single artificial neural network or a plurality of artificial neural networks.

In FIG. 4, the figure of merit (FOM) of the semiconductor device is illustrated using power delay product (PDP) as an example. However, the FOM may vary significantly depending on the application or criteria used. The FOM may include, but is not limited to, metrics such as power delay product (PDP), frequency, ring oscillator delay (ROD), power dissipation, IR drop, etc.

FIG. 5 is a graph illustrating a non-linear sensitivity decomposition (NLSD) method. This method may be applied to a method for evaluating the influence of a process on semiconductor device performance according to an embodiment of the present disclosure.

Referring to FIG. 5, x₁ may be an axis corresponding to PC1 (principal component 1), x₂ may be an axis corresponding to PC2 (principal component 2). y may be an axis corresponding to a figure of merit (FOM) of a semiconductor device, X₀ may correspond to a coordinate of the origin, and Xₜ may correspond to a coordinate of the target. In the simple example illustrated in FIG. 5, the coordinate (PC1, PC2) of the origin may be (0, 0), and the coordinate (PC1, PC2) of the target may be (2, 2).

The figure of merit (FOM) of the semiconductor device may exhibit nonlinear characteristics in its relationship with PCs. Therefore, it may be desirable to perform an input influence decomposition evaluation suitable for such nonlinear characteristics. The input influence decomposition evaluation suitable for the nonlinear characteristics may be a non-linear sensitivity decomposition (NLSD) method.

When PC1 (i.e., x₁) changes from 0 to 2, the change in the FOM resulting from the change in PC1 (i.e., x₁) may be determined using the NLSD method proposed in this embodiment. More specifically, the range of PC1 from 0 to 2 may be divided into n equal parts (here, 5 equal intervals), and similarly, the range of PC2 from 0 to 2 may also be divided into n equal parts (here, 5 equal intervals). Consequently, each interval (or cell) for the 5-equal intervals of PC1 corresponds to 0.4, and each interval (or cell) for the 5-equal intervals of PC2 also corresponds to 0.4.

To determine the change in the FOM resulting from the change in PC1 (i.e., x₁), the following differences are calculated sequentially: a difference value (Δy_{1,1}) between an output value with input (0, 0) and an output value with input (0.4, 0), a difference value (Δy_{1,2}) between an output value with input (0.4, 0.4) and an output value with input (0.8, 0.4), a difference value (Δy_{1,3}) between an output value with input (0.8, 0.8) and an output value with input (1.2, 0.8), a difference value (Δy_{1,4}) between an output value with input (1.2, 1.2) and an output value with input (1.6, 1.2), and a difference value (Δy_{1,5}) between an output value with input (1.6, 1.6) and an output value with input (2, 1.6). The sum of all these difference values Δy_{1,1}, Δy_{1,2}, Δy_{1,3}, Δy_{1,4}, and Δy_{1,5} may represent the influence level of PC1 (i.e., x₁) on the FOM. This process may correspond to the input influence decomposition evaluation as explained with reference to mathematical expressions 11 to 14.

In addition, to determine the change in the FOM resulting from the change in PC2 (i.e., x₂), the following differences are calculated sequentially: a difference value (Δy_{2,1}) between an output value with input (0, 0) and an output value with input (0.4, 0), a difference value (Δy_{2,2}) between an output value with input (0.4, 0.4) and an output value with input (0.8, 0.4), a difference value (Δy_{2,3}) between an output value with input (0.8, 0.8) and an output value with input (1.2, 0.8), a difference value (Δy_{2,4}) between an output value with input (1.2, 1.2) and an output value with input (1.6, 1.2), and a difference value (Δy_{2,5}) between an output value with input (1.6, 2) and an output value with input (2, 1.6), the sum of all these difference values Δy_{2,1,} Δy_{2,2}, Δy_{2,3}, Δy_{2,4}, and Δy_{2,5} may represent the influence level of PC2 (i.e., x₂) on the FOM. This process may also correspond to the input influence decomposition evaluation explained with reference to mathematical expressions 11 to 14 in the foregoing paragraphs.

FIG. 5 provides a simplified example; however, the actual number of PCs may be two or more, with the values (coordinate values) of at least two PCs differing from one another. Regardless of these differences, the range between the origin and each PC can still be divided into n equal parts.

For the figure of merit (FOM) of a semiconductor device exhibiting nonlinear characteristics in relation to PCs, the influence level of each PC on the FOM may be determined using the method described in this embodiment.

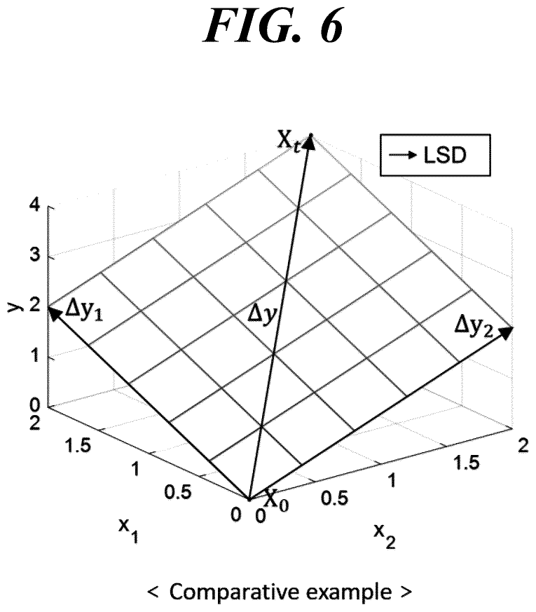

FIG. 6 is a graph illustrating an LSD (linear sensitivity analysis) method according to a comparative example.

Referring to FIG. 6, this illustrates a case where the y value exhibits a linear relationship with changes in x₁ and x₂. In this case, the output value obtained with input (2, 0) represents the influence of x₁ on y (i.e., y₁). Similarly, the output value obtained with input (0, 2) represents the influence of x₂ on y (i.e., y₂).

However, as mentioned above, the figure of merit (FOM) of semiconductor devices may exhibit nonlinear characteristics in relation to PCs, making it difficult to accurately evaluate the influence using the LSD method, as shown in FIG. 6. Specifically, as illustrated in FIG. 5, if the graph exhibits nonlinear characteristics, the displayed y₁ may not accurately represent the influence of PC1 (i.e., x₁) on the FOM, and the displayed y₂ may not accurately represent the influence of PC2 (i.e., x₂) on the FOM. Therefore, for a target (evaluation target) having nonlinear characteristics, the influence of each PC on the FOM can be derived using the input influence decomposition evaluation described with reference to, for example, mathematical expressions 11 to 14.

The technology according to embodiments of the present disclosure may be performed for individual samples and may be performed by numerical integration without analytical expressions such as matrices and vectors.

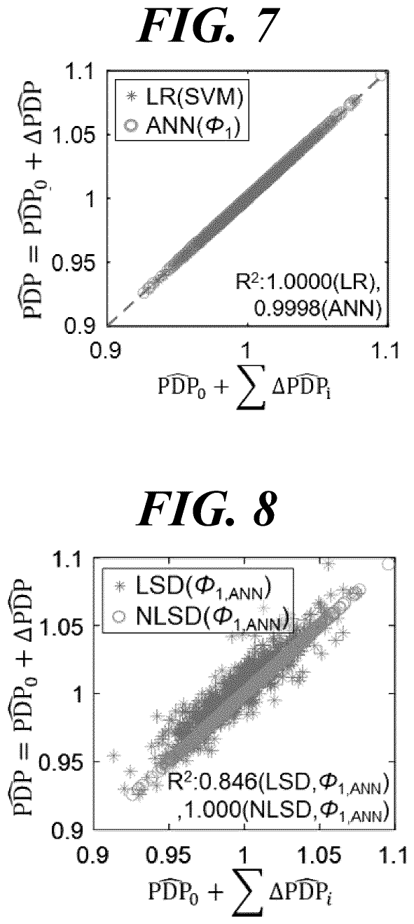

FIG. 7 is a scatter plot of the summation of decomposed sensitivities according to the NLSD method of LR (linear regression) and ANN (artificial neural network). In FIG. 7, PDP represents an output value, PDP₀ represents a zero input response, and ΣΔPDPᵢ represents decomposed sensitivities.

Referring to FIG. 7, it can be observed that when the separated influences (i.e., decomposed sensitivities) ΔPDPᵢ for each input's PDP are added in the nonlinear model (i.e., ANN), the overall output is successfully restored. When the NLSD method is performed using ANN, the coefficient of determination (R²) approaches 1 (R²˜1). This indicates that when the NLSD method is used according to the embodiment of the present disclosure, the influences of the inputs are successfully decomposed.

FIG. 8 is a scatter plot of the summation of decomposed sensitivities according to the LSD and NLSD methods of the nonlinear model.

Referring to FIG. 8, it can be observed that in the case of the LSD method, the coefficient of determination (R²) is 0.846, indicating low accuracy. However, in the case of the NLSD method, the coefficient of determination (R²) is 1, demonstrating excellent accuracy.

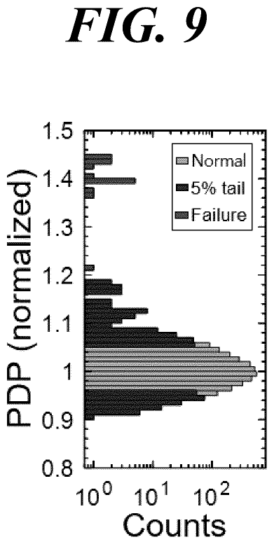

FIG. 9 is a graph illustrating the distribution of FOM data corresponding to a PDP according to an embodiment of the present disclosure.

Referring to FIG. 9, it shows the PDP histogram of all samples (i.e., semiconductor device samples), including the top/bottom 5% tail distribution and failure samples. The X-axis represents the number of samples, while the Y-axis shows the normalized PDP measurement value. Here, the top 5% tail distribution and the bottom 5% tail distribution can be observed, along with the distribution of failure samples. A higher PDP value may correspond to the lower performance of the semiconductor device.

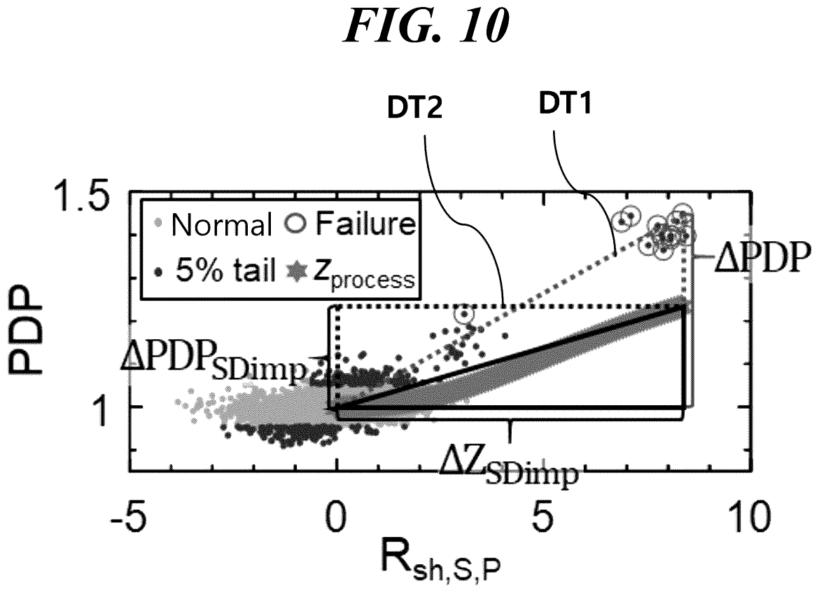

FIG. 10 is a graph illustrating results obtained by separately evaluating the influence of a process group SDimp (source/drain implantation & silicidation) on a PDP in a sample (device sample) with the maximum defect in the results of FIG. 9, according to an embodiment of the present disclosure.

Referring to FIG. 10, R_{sh,S,P} represents the sheet resistance of a source of a PMOS (p-channel metal-oxide-semiconductor) transistor device. PDP_{SDimp} represents the PDP influence of the process group SDimp. R_{sh,S,P} may be EPMs belonging to the process group SDimp. Analysis may be performed on the sample with the highest PDP value (i.e., the sample with the maximum defect) among the failure samples. The length (vertical length) of the right segment of the first dotted triangle DT1 may represent the total PDP. The total PDP may be the difference (approximately 0.45) between an average PDP value of a normal device (approximately 1) and the PDP value of the sample with the highest PDP value (i.e., the sample with the maximum defect) (approximately 1.45). This analysis may clarify the influence (PDP) that each process has on the total PDP.

While z_{process} traces the influence (PDP) generated when calculated with NLSD, the PC difference from the origin is divided into 100 equal intervals. The influence for each section is measured and displayed, showing the cumulative influence as it progresses to the right of the graph. Therefore, the length (vertical length) of the left line segment of the second dotted triangle DT2 represents the influence of the PDP due to the process group SDimp. This influence is calculated by applying the same method to all parameters (i.e., PCs) belonging to the process group SDimp, including R_{sh,S,P}, and the influence corresponding to z_{process} is illustrated by adding up all the influences. Z_{SDimp} indicates that the total influence of all parameters (i.e., PCs) belonging to the process group SDimp.

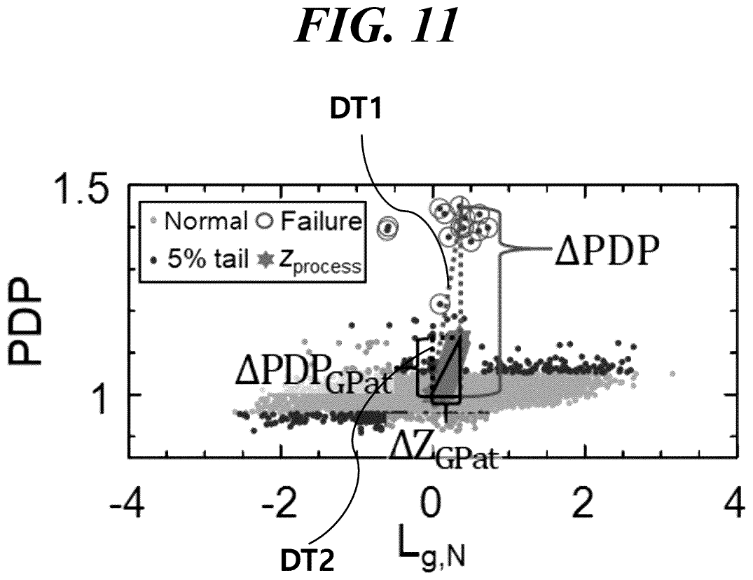

FIG. 11 is a graph showing results obtained by separately evaluating the influence of a process group GPat (gate patterning) on the PDP in the sample (device sample) with the maximum defect in the results of FIG. 9, according to an embodiment of the present disclosure.

Referring to FIG. 11, L_{g,N} represents the gate length of an NMOS (n-channel metal-oxide-semiconductor) transistor device. PDP_{GPat} represents the PDP influence of the process group GPat. L_{g,N} may be an EPM belonging to the process group GPat. Analysis may be performed on the sample with the highest PDP value (i.e., the sample with the maximum defect) among the failure samples. A method similar to the one performed for FIG. 10 may likewise be performed for FIG. 11. Therefore, the length (vertical length) of the left line segment of the second dotted triangle DT2 represents the influence of the PDP due to the process group GPat. Z_{GPat} indicates that the influences of all parameters (i.e., PCs) associated with the process group GPat are aggregated. In FIG. 10 and FIG. 11, PDPs may represent predicted values.

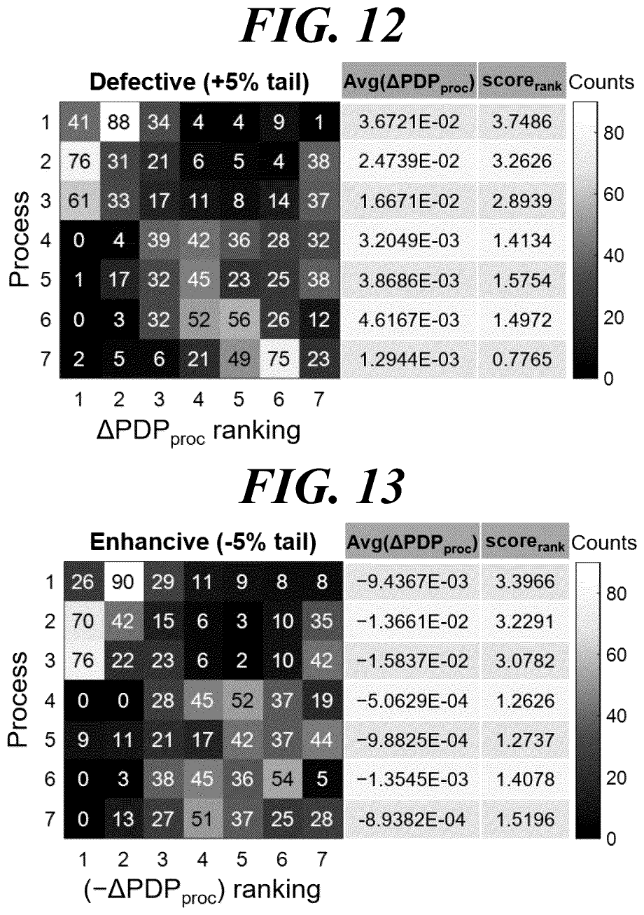

FIG. 12 illustrates a heatmap showing the influence rankings of process groups within the top 5% of defective PDP distribution, along with the corresponding average PDP influence values and ranking scores, according to an embodiment of the present disclosure.

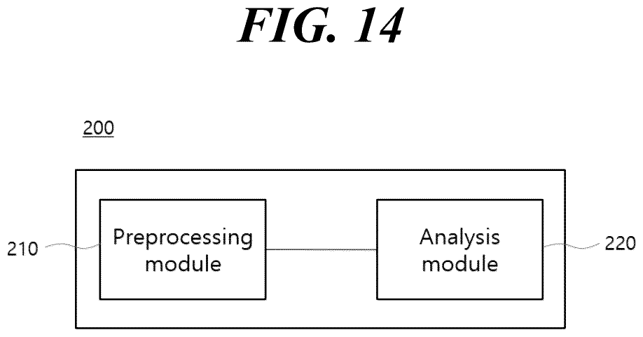

FIG. 13 shows a heatmap showing the influence rankings of process groups within the bottom 5% of enhancive PDP distribution, along with the corresponding average PDP influence values and ranking scores, according to an embodiment of the present disclosure.

The process groups corresponding to Processes 1, 2, 3, 4, 5, 6, and 7 in FIGS. 12 and 13 are as follows.
Process 1: S/D implantation [R_{sh(Imp/M0C),(S/D),(N/P)}]
Process 2: Gate patterning [L_{g(N/P)}, W_{g(N/P)}]
Process 3 Gate oxidation [T_{ox(N/P)}, r_{poly-dep(N/P)}]
Process 4: Interconnect metalization [R_{sh,M0}]
Process 5 Poly-Si implantation [R_{sh(poly/MOC),(N/P)}]
Process 6: M0 contact metalization [R_{sh,MOC(S/D/G/B)}]
Process 7 Well implantation [R_{sh,well(N/P)}]

Each of the Processes 1, 2, 3, 4, 5, 6, and 7 may include a plurality of EPMs and corresponding PCs. Each of the Processes 1, 2, 3, 4, 5, 6, and 7 may have a corresponding EPM group.

FIG. 12 and FIG. 13 present the results obtained by separately evaluating the influence of each process on PDP within a 5% tail distribution.

Referring to FIG. 12, for the top 5% of defective devices, it is possible to identify the unit process (or unit process group) associated with a high PDP. The PDPₚᵣₒc ranking on the X-axis represents the value of the influence of the process on the PDP, ranked sequentially from Process 1 to Process 7. Therefore, the process with the largest PDP may be determined as the first rank.

The fact that Process 1 is ranked first with a value of 41 indicates that Process 1 was associated with 41 devices that exhibited the greatest influence on PDP. The distribution of the ranking of influence on PDP by process is illustrated as a heatmap. Avg(PDP_{proc}) is an average PDP influence value calculated for each process. scoreᵣₐₙₖ is a ranking score calculated for each process. Scoreᵣₐₙₖ is given by assigning different scores to each rank, with a value reflecting the frequency of each rank. According to the embodiment of the present disclosure, Process 1 can be identified as having the most issues when evaluated based on the value of Avg(PDP_{proc}).

Referring to FIG. 13, for the lower 5% of enhancive devices, it is possible to identify the unit process (or unit process group) associated with a low PDP. Process 3 shows the highest Avg(PDP_{proc}). Process 1 shows the highest scoreᵣₐₙₖ. Avg(PDP_{proc}) and scoreᵣₐₙₖ may be different evaluation criteria. In FIG. 12 and FIG. 13, both PDPs may be predicted values.

As described with reference to FIGS. 12 and 13, in the embodiment of the present disclosure, the influence of unit processes (or unit process groups) on FOM may be quantitatively and accurately identified.

The method for evaluating the influence of a process on the performance of a semiconductor device according to the embodiments described above may be applied to various fields. For example, the method may be usefully applied to a method for setting semiconductor device manufacturing parameters.

FIG. 14 illustrates a device 200 for evaluating the influence of a process on semiconductor device performance according to an embodiment.

Referring to FIG. 14, the device 200 may include a preprocessing module 210 and an analysis module 220. The term “module” in this specification may refer to a functional and structural combination of hardware that implements the technological concept of the present disclosure, along with software required to operate the hardware. For example, the “module” may refer to a logical unit comprising predetermined code and hardware resources required to execute the predetermined code. It does not necessarily imply physically connected code or a specific type of hardware.

The preprocessing module 210 is configured to obtain an EPM data set including a plurality of electrical measurement parameters (EPMs) measured from a plurality of semiconductor device samples manufactured under a plurality of different process conditions, to group correlated EPMs within the EPM data set to establish a plurality of EPM groups, and to perform data component analysis on each of the plurality of EPM groups to derive a plurality of PCs (principal components) for the EPMs within the plurality of EPM groups.

The analysis module 220 is configured to sum the influences of the plurality of PCs on the FOM for each EPM group to determine the degree of influence of each of the plurality of PCs on the FOM of the semiconductor device. Additionally, it derives the influence of a unit process or a unit process group corresponding to the EPM group by training an artificial neural network to predict a figure of merit (FOM) of the semiconductor device based on the plurality of PCs from the plurality of EPM groups. It then performs an input influence evaluation on each of the plurality of PCs for an individual semiconductor device sample selected from the plurality of semiconductor device samples using the trained artificial neural network.

According to one embodiment, the analysis module 220 is configured to perform the input influence decomposition evaluation in a non-linear sensitivity decomposition (NLSD) manner.

According to one embodiment, when Z in mathematical expression 21 below represents one semiconductor device sample including all PCs, and z (i.e., z₁, z₂, . . . , zᵢ, . . . , z_{D}) represents each PC of the one semiconductor device sample, the analysis module 220 is configured to derive the influence of a specific PC corresponding to the i-th input (zᵢ) on the FOM by deriving the difference value between the first output value and the second output value of the artificial neural network.

The first output value is obtained when the values corresponding to the mathematical expression 22 below are used as the first input group, and the second output value is obtained when the values corresponding to the mathematical expression 23 below are used as the second input group. A plurality of difference values are summed, as described in mathematical expression 24 below, through the input influence evaluation.

$$Z = [ \begin{matrix}{z}_{1} & {z}_{2} & … & {z}_{i} & … & {z}_{D}\end{matrix} ] \qquad < Mathematical Expression 1 >$$

$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$

$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$

$${\sum }_{j = 0}^{n - 1} \qquad < Mathematical Expression 4 >$$

Here, when dividing the interval corresponding to the difference of each PC of the PC coordinate (Zₜ) of the semiconductor device sample corresponding to a target with respect to the PC coordinate (Z₀) corresponding to the origin into n equal sections, and adding up the difference values for the i-th input (zᵢ) obtained individually in the n sections, so that when the influence of the predetermined PC on the FOM may be derived, if the j is 0, it may correspond to the first section among the n sections, and if the j is n−1, it may correspond to the last section among the n sections. Zₜⱼ is the first input group, and z₁ₜⱼ, z₂ₜⱼ, . . . , z₁ₜⱼ, . . . , z_{Dtj} may correspond to input values of Zₜⱼ. Zₜⱼ is the second input group, and z₁ₜⱼ, z₂ₜⱼ, . . . , z₁ₜⱼ₊₁), . . . , z_{Dtj} may correspond to the input values of Zₜⱼ^{I+}.

According to one embodiment, the semiconductor device sample corresponding to the origin may be a semiconductor device sample manufactured under baseline conditions corresponding to basic experimental conditions. A semiconductor device sample corresponding to the target may be set for the semiconductor device sample corresponding to the origin, and then, an evaluation may be performed on the semiconductor device sample corresponding to the target.

However, in some cases, the semiconductor device sample corresponding to the origin may not be a semiconductor device sample manufactured under the baseline conditions. Alternatively, the origin may be determined as a point which is average of the entire semiconductor device sample set. In addition, the PC characteristics (or EPM characteristics) of the semiconductor device sample to be analyzed may be determined as the target point.

According to one embodiment, the analysis module 220 is configured to derive the influence of the unit process or the unit process group corresponding to the EPM group by performing the input influence decomposition evaluation for each of the plurality of semiconductor device samples, and adding up the influences on the FOM derived from the plurality of PCs for each of the plurality of semiconductor device samples by EPM group.

The various features of the method for evaluating the influence of a process on the performance of a semiconductor device described with reference to FIGS. 1 to 5 and FIGS. 7 to 13 may all be applied to an apparatus for evaluating the influence of a process on the performance of a semiconductor device according to the embodiments of the present disclosure, provided they do not contradict each other.

The device for evaluating the influence of a process on the performance of a semiconductor device according to the embodiments of the present disclosure may be applied to various fields. For example, the device may be usefully applied to a device for setting semiconductor device manufacturing parameters.

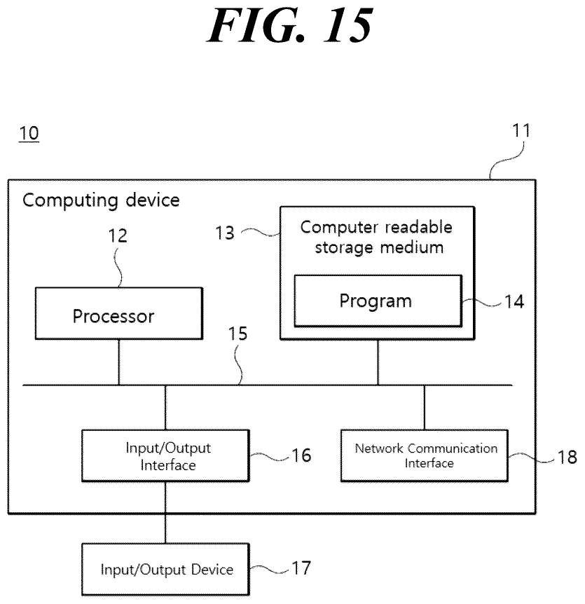

FIG. 15 illustrates a computer system 10 for implementing a method for evaluating the influence of a process on semiconductor device performance according to an embodiment of the present disclosure.

Referring to FIG. 15, the computer system 10 includes a computing device 11. The computing device 11 may serve as, or include an apparatus for evaluating the influence of a process on semiconductor device performance. The computing device 11 may include at least one processor 12, a computer-readable storage medium 13, and a communication bus 15. The processor 12 may allow the computing device 11 to perform operations according to the embodiments described above. The processor 12 may execute one or more programs 14 stored in the computer-readable storage medium 13. The one or more programs 14 may include one or more computer-executable instructions. When the computer-executable instructions are executed by the processor 12, they may cause the computing device 11 to perform the operations according to the embodiments.

The computer-readable storage medium 13 is configured to store computer-executable instructions or program code, program data, and/or other suitable forms of information. The program 14 stored in the computer-readable storage medium 13 may include a set of instructions which may be executed by the processor 12. When executed by the computing device 11 including the one or more processors 12, one or more instructions included in the program 14 may cause the computing device 11 to perform operations according to the embodiments described above. The operations according to the embodiments may include the operations, the related features described with reference to FIGS. 1 to 5 and FIGS. 7 to 13, and the like. According to an embodiment of the present disclosure, the computer-readable storage medium 13 may include a memory, such as a volatile memory (e.g., random access memory), a nonvolatile memory, or a suitable combination thereof, one or more magnetic disk storage devices, optical disk storage devices, flash memory devices, or any other type of storage medium accessible by the computing device 11 and capable of storing desired information, or a combination thereof.

The communication bus 15 may interconnect various components of the computing device 11, including the processor 12 and the computer-readable storage medium 13. Additionally, the computing device 11 may include one or more input/output interfaces 16, connecting to one or more input/output devices 17, and one or more network communication interfaces 18. The input/output interface 16 and the network communication interface 18 may be connected via the communication bus 15. The input/output device 17 may be connected to other components of the computing device 11 via the input/output interface 16. For example, the input/output device 17 may include input devices such as a pointing device (e.g., a mouse or trackpad), a keyboard, a touch input device (e.g., a touchpad or a touchscreen), a voice or sound input device, various types of sensor devices, and/or photographing devices, and/or output devices such as a display device, a printer, a speaker, and/or a network card. The input/output device 17 may be integrated into the computing device 11 as a constituting component or connected externally as a separate device distinct from the computing device 11.

According to the embodiments of the present disclosure described above, the method and device for evaluating the influence of a process on the performance of a semiconductor device can accurately separate and evaluate the influence of each unit process on the performance of the semiconductor device using input influence evaluation, thereby clarifying the influence of individual unit processes. In addition, according to the embodiments of the present disclosure, the method and device can evaluate the process influence on both defective and well-functioning devices (i.e., device with excellent performance) by directly deriving the influence from each sample, rather than using a sample group of semiconductor devices. The method and device can be effectively applied, for example, to setting semiconductor device manufacturing parameters.

In the present specification, the preferred embodiments of the present disclosure have been disclosed, and although specific terms are used, these are only used in a general sense to easily describe the technological contents of the present invention and to help the understanding of the present invention, and are not used to limit the scope of the present invention. It will be apparent to those of ordinary skill in art to which the present invention pertains that other modifications based on the technological spirit of the present invention may be implemented in addition to the embodiments disclosed herein. It will be appreciated by those skilled in art that the method and device for evaluating influence of a process on semiconductor device performance, as described with reference to FIGS. 1 to 5 and FIGS. 7 to 15, and their applications, may be variously substituted, altered, or modified without departing from the spirit of the present invention. Therefore, the scope of the invention should not be determined solely by the described embodiments, but by the technological concepts outlined in the claims.

What is claimed is:

1. A method for evaluating influence of a process on performance of a semiconductor device, the method comprising:
obtaining an EPM data set that includes a plurality of electrical measurement parameters (EPMs) measured from a plurality of semiconductor device samples manufactured under a plurality of different process conditions;
establishing a plurality of EPM groups by grouping EPMs that exhibit correlations within the EPM data set;
performing data component analysis on each of the plurality of EPM groups to derive a plurality of principal components (PCs) for the EPMs within the plurality of EPM groups;
training an artificial neural network to output a figure of merit (FOM) for the semiconductor device by using the plurality of PCs derived from the plurality of EPM groups as inputs;
performing an input influence evaluation for each PC of individual semiconductor device samples selected from the plurality of semiconductor device samples using the trained artificial neural network to determine the degree of influence each PC has on the FOM for the semiconductor device; and
summing the influences of the plurality of PCs on the FOM within each EPM group to determine influence of a unit process or unit process group corresponding to the EPM group.

2. The method of claim 1, wherein the input influence evaluation is performed by using a non-linear sensitivity decomposition (NLSD) method.

3. The method of claim 1, wherein when Z represents one semiconductor device sample including a plurality of PCs, and z (i.e., z₁, z₂, . . . , zᵢ, . . . , z_{D}) represents each PC of the one semiconductor device sample in the following mathematical expression 1, the input influence evaluation comprises:
determining an influence degree of a given PC corresponding to the i-th input (zᵢ) on the FOM by obtaining a difference value between a first output value of the trained artificial neural network derived when values corresponding to mathematical expression 2 below are used as a first input group and a second output value of the trained artificial neural network derived when values corresponding to mathematical expression 3 below are used as a second input group; and
adding up a plurality of difference values using mathematical expression 4 below,
$$Z = [ \begin{matrix}{z}_{1} & {z}_{2} & … & {z}_{i} & … & {z}_{D}\end{matrix} ] \qquad < Mathematical Expression 1 >$$
$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$
$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$
$$< Mathematical Expression 4 >$$
where, in a case that an interval corresponding to a difference value of each PC of a PC coordinate (Zₜ) of a semiconductor device sample corresponding to a target with respect to a PC coordinate (Z₀) corresponding to an origin is divided into n equal sections, and the difference value for the i-th input (zᵢ) obtained individually in the n sections are added up to determine the influence of the given PC on the FOM,
when a j is 0 (i.e., j=0), it corresponds to the first section among the n sections, and when the j is n−1, it corresponds to the last section among the n sections,
the Zₜⱼ is the first input group, and z₁ₜⱼ, z₂ₜⱼ, . . . , z₁ₜⱼ, . . . , z_{Dtj} correspond to input values within the Zₜⱼ, the Zₜⱼ^{I+} is the second input group, and the z₁ₜⱼ, z₂ₜⱼ, . . . , zᵢₜ₍ⱼ₊₁₎, . . . , z_{Dtj} correspond to input values within the Zₜⱼⁱ⁺.

4. The method of claim 3, wherein the semiconductor device sample corresponding to the origin is a semiconductor device sample manufactured according to baseline conditions corresponding to basic experimental conditions.

5. The method of claim 1, wherein the influence of the unit process or unit process group corresponding to each EPM group on the FOM is determined by performing the input influence evaluation for each of the plurality of semiconductor device samples and summing the influences on the FOM determined from the plurality of PCs for each of the plurality of semiconductor device samples by EPM group.

6. A method for setting semiconductor device manufacturing parameters, comprising the method of claim 1.

7. An apparatus for evaluating influence of a process on performance of a semiconductor device, the apparatus comprising:
a preprocessing module; and
an analysis module,
wherein the preprocessing module is configured to:
obtain an EPM data set that includes a plurality of electrical measurement parameters (EPMs) measured from a plurality of semiconductor device samples manufactured under a plurality of different process conditions;
establish a plurality of EPM groups by grouping EPMs that exhibit correlations within the EPM data set;
perform data component analysis on each of the plurality of EPM groups to derive a plurality of principal components (PCs) for the EPMs within the plurality of EPM groups, and
wherein the analysis module is configured to:
train an artificial neural network to output a figure of merit (FOM) for the semiconductor device by using the plurality of PCs derived from the plurality of EPM groups as inputs;
derive degree of influence each PC has on the FOM of the semiconductor device by performing an input influence evaluation for each PC of individual semiconductor device samples selected from the plurality of semiconductor device samples using the trained artificial neural network; and
summing the influences of the plurality of PCs on the FOM within each EPM group to determine influence of a unit process or unit process group corresponding to the EPM group.

8. The apparatus of claim 7, wherein the analysis module is configured to perform the input influence evaluation by using a non-linear sensitivity decomposition (NLSD) method.

9. The apparatus of claim 7, wherein when Z represents one semiconductor device sample including a plurality of PCs, and z (i.e., z₁, z₂, . . . , zᵢ, . . . , z_{D}) represents each PC of the one semiconductor device sample through an input influence decomposition evaluation, in mathematical expression 1 below,
the analysis module is configured to determine an influence degree of a given PC corresponding to the i-th input (zᵢ) on the FOM by obtaining a difference value between a first output value of the trained artificial neural network derived when values corresponding to mathematical expression 2 below are used as a first input group, and a second output value of the trained artificial neural network derived when values corresponding to mathematical expression 3 below are used as a second input group, and adding up a plurality of difference values using mathematical expression 4 below,
$$Z = [ \begin{matrix}{z}_{1} & {z}_{2} & … & {z}_{i} & … & {z}_{D}\end{matrix} ] \qquad < Mathematical Expression 1 >$$
$${Z}_{tj} = [ \begin{matrix}{z}_{{1}_{tj}} & {z}_{{2}_{tj}} & … & {z}_{{i}_{tj}} & … & {z}_{{D}_{tj}}\end{matrix} ] \qquad < Mathematical Expression 2 >$$
$${Z}_{{tj}^{i +}} = [ \begin{matrix}{z}_{{1}_{tj}} & {z}_{{2}_{tj}} & … & {z}_{{i}_{t ( j + 1 )}} & … & {z}_{{D}_{tj}}\end{matrix} ] \qquad < Mathematical Expression 3 >$$
$${\sum }_{j = 0}^{n - 1} \qquad < Mathematical Expression 4 >$$
where, when dividing an interval corresponding to a difference value of each PC of a PC coordinate (Zₜ) of a semiconductor device sample corresponding to a target with respect to a PC coordinate (Z₀) corresponding to an origin into n equal sections, and adding up difference values for the i-th input (zᵢ) obtained individually in the n sections to derive the influence of the given PC on the FOM, if a j is 0 (i.e., j=0), it corresponds to the first section among the n sections, and if the j is n−1, it corresponds to the last section among the n sections,
the Zₜⱼ is the first input group, and the z₁ₜⱼ, z₂ₜⱼ, . . . , z₁ₜⱼ, . . . , z_{Dtj} correspond to input values within the Zₜⱼ,
the Zₜⱼⁱ⁺ is the second input group, and the z₁ₜⱼ, z₂ₜⱼ, . . . , zᵢₜ₍ⱼ₊₁₎, . . . , z_{Dtj} correspond to input values within the Zₜⱼⁱ⁺.

10. The apparatus of claim 9, wherein the semiconductor device sample corresponding to the origin is a semiconductor device sample manufactured under baseline conditions corresponding to basic experimental conditions.

11. The apparatus of claim 7, wherein the analysis module is configured to determine the influence of the unit process or unit process group corresponding to the EPM group on the FOM by performing the input influence evaluation for each of the plurality of semiconductor device samples and summing the influences on the FOM determined from the plurality of PCs for each of the plurality of semiconductor device samples by EPM group.

12. A semiconductor device manufacturing parameter setting apparatus including the apparatus of claim 7.

13. A computer program stored in a non-transitory computer readable storage medium, and including one or more instructions, which, when executed by one or more processors, performs a method comprising:
obtaining an EPM data set that includes a plurality of electrical measurement parameters (EPMs) measured from a plurality of semiconductor device samples manufactured under a plurality of different process conditions;
establishing a plurality of EPM groups by grouping EPMs that exhibit correlations within the EPM data set;
deriving a plurality of principal components (PCs) for the EPMs within the plurality of EPM groups by performing data component analysis on each of the plurality of EPM groups;
training an artificial neural network to output a figure of merit (FOM) for a semiconductor device by using the plurality of PCs derived from the plurality of EPM groups as inputs;
determining the degree of influence PC has on the FOM for the semiconductor device by performing an input influence evaluation for each PC of individual semiconductor device samples selected from the plurality of semiconductor device samples using the trained artificial neural network; and
summing the influences of the plurality of PCs on the FOM within each EPM group to determine influence of a unit process or unit process group corresponding to the EPM group.
